(19) United States
(12) Patent Application Publication
(10) Pub. No.: US 2015/0274086 A1
(43) Pub. Date: Oct. 1, 2015

(54) TRAILER HITCH SHORT FLAG

(71) Applicant: John Moak, Saint Joseph, MO (US)

(72) Inventor: John Moak, Saint Joseph, MO (US)

(21) Appl. No.: 14/668,925

(22) Filed: Mar. 25, 2015

Related U.S. Application Data
(60) Provisional application No. 61/970,246, filed on Mar. 25, 2014.

(51) Int. Cl. B60R 9/06

(52) U.S. Cl. CPC B60R 9/06; B60R 2011/004

(57) ABSTRACT

The Trailer Hitch Flag components include an insertable flag pole structure comprising a box coupling for insertion into a trailer hitch in four differently sized versions measuring approximately one and one quarter inches, two inches, three and one quarter inches, and five and one quarter inches.

### CLAIM OF PRIORITY

This patent application claims priority under 35 USC 119 (e) (1) from U.S. Provisional Patent Application Ser. No. 61/970,246 filed Mar. 25, 2014, of common inventorship herewith entitled, “Trailer Hitch Short Flag,” which is incorporated herein by reference as though the same were set forth in its entirety.

### FIELD OF THE INVENTION

The present invention pertains to the field of trailer hitches, and more specifically to the field of functional hitch receivers for displaying a flag or pennant.

### BACKGROUND OF THE INVENTION

The prior art has put forth several designs for functional hitch receivers. Among these are:

U.S. Pat. No. 6,808,098 to Earl H. Bickett, III and Keith N. Bickett describes a flag mast holder assembly that accommodates the three most popular trailer hitch ball mount bore diameters. Mast holder assembly includes a central bore for receiving the mast of a flag or pennant and is preferably made of aluminum. The mast holder assembly is provided with stainless steel flat washers, lock washer and securing nut. The provision of stainless steel components with the aluminum mast body is highly resistant to corrosion and oxidation, and provides an attractive addition to anyone's vehicle. The preferred material is aluminum with stainless components.

US Patent 2005/0108909 to Gregory F. Andersen describes a vehicle mounted flag holder constructed to be fastened to the rear of a vehicle, inserted into a conventional hitch receiver or to a bumper or bar hitch mount, depending upon how the vehicle is equipped. The flag holder has a provision for securely supporting a flagpole in a vertical position for display of a flag of substantial size while the vehicle is in motion or parked. The flag holder also has provision for rotating and securing the flagpole rearwardly to allow opening of a vehicle rear door or tail gate. Another embodiment supports two flagpoles, each displaying a flag. The flag holder is preferably made of steel or aluminum and the flagpoles are made of composite or contain spring material to allow for flex in high winds. The flagpole is adjustable in height for a particular vehicle.

U.S. Pat. No. D531,932 to David M. Thompson describes an ornamental design for a novelty flag display. The flag, pole and top ball are hitched into a standard vehicle's receiver hitch.

None of these prior art references describe the present invention.

### SUMMARY OF THE INVENTION

It is an object of the present invention to provide a sturdy mechanism that connects a safety pole extension on the rear of any hitch equipped vehicle and functions to securely hold a flag or pennant.

### BRIEF DESCRIPTION OF THE DRAWINGS

FIG. 1 is an illustrative prototypical functional side view showing the present invention installed in a pickup truck's receiver hitch and securely holding a national flag.

FIG. 2 is a prototypical close up diagonal view showing the present invention constructed in a strong metal material with a pin and cotter securement functionality.

FIG. 3 is a prototypical close up diagonal view showing the present invention functionally installed in a vehicle's receiver hitch.

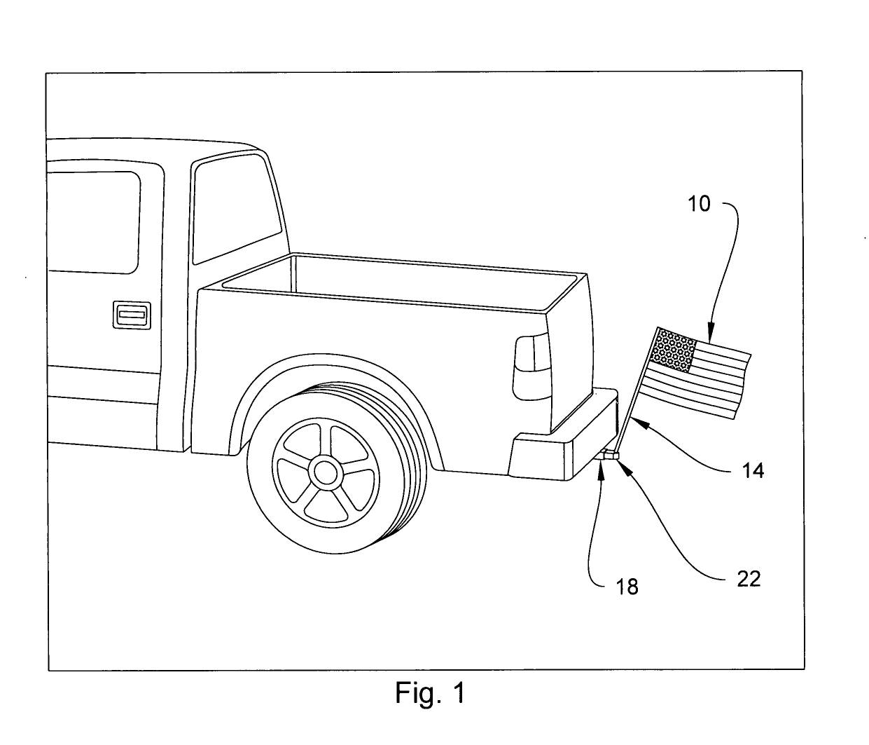

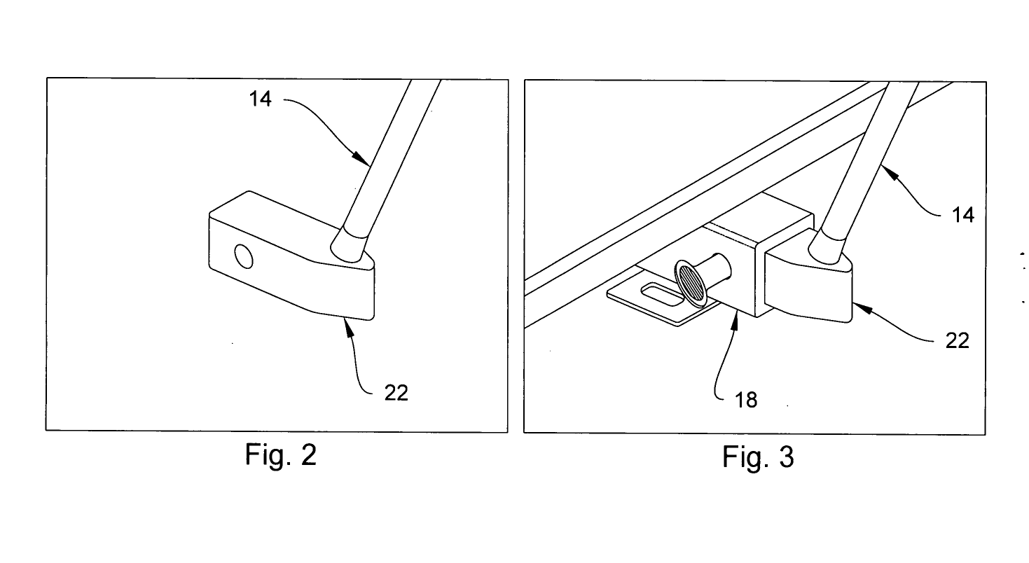

### DETAILED DESCRIPTION OF THE INVENTION

Showing support for one's favorite team is an engrossing part of any sports fan's regular routine. People love to advertise their support of different teams and players. All manner of different promotional ephemera related to sporting teams are developed as a result of fan support and infatuation, from giant foam fingers and banded sports jerseys to posters and even bobble head dolls honoring specifically prolific players. Tuning in to a pervading ethic of one's team is a great way to find recognition in an already existing community and to encourage one's family, friends and even coworkers to also get on the bandwagon. Supporting a local team is an important part of integrating oneself into a community at large, offering a universally acknowledged expression of solidarity with others in one's own neighborhood. As cheering on sports teams during regular events is an important part of the social construct in many different jurisdictions, participation in this regular exuberance is an incredibly emotionally beneficial pastime for many committed fans.

Celebrating team game days and victories is perhaps the most exuberant part of any sports fanaticism. Whenever a favored team is doing well or simply even participating, its fans are programmed to go a little wild, celebrating with shows of support in the form of flags and other ephemera sporting a team's colors. Flying a flag is seen as the ultimate form of respect, elevating the team to the same height as the nation in the peak of one's patriotic fervor. Showing colors is an age old ritual designed to directly reinforce social structures which underpin a team's local significance. Even non fans often desire to display the correct pennants out of a loyal sense of communal civic duty towards excellence.

Flying a flag is difficult, especially in the world of automobiles. While there is a considerable precedent for diplomatic ensigns hoisted on small poles above the front wheel wells of state automobiles, most cars and trucks offer no stock device to which a flag is safely connected for display while driving. The forces engendered by a large panel of fabric batting in a fricative manner against the onrushing air of a vehicle at speed is considerable and few effective aftermarket solutions to this conundrum are available that fit into a reasonable budget of a dedicated home team fan.

The present invention, hereinafter referred to as the Trailer Hitch Short Flag, or simply Trailer Hitch Flag, is a sturdy mechanism 10 that connects a pole extension on the rear of any hitch equipped vehicle. This pole extension accommodates securely holding a flag adornment. The Trailer Hitch Flag allows consumers to display a flag of their choice while it also serves as a safety component preventing people and vehicles from hitting the trailer hitch. The majority of flag systems already on the market are expensive, confusing and extraneous. The Trailer Hitch Flag system is developed with both simplicity and economy in mind. The present invention is a sturdy mechanism that reliably connects with all manner of existing trailer hitches to produce a safe flag displaying pole extension on the rear of any hitch equipped vehicle when the hitch is free from performing towing duties. The Trailer Hitch Flags system also acts as an additional safety device, ensuring that users correctly decouple their trailer hitch balls after every towing instance and replace it with a high visibility indicator that encourages greater standoff distance by vehicles approaching from the rear.

The Trailer Hitch Flag components include an insertable flag pole structure comprising a box coupling 22 in four differently sized versions measuring approximately one and one quarter inches, two inches, three and one quarter inches, and five and one quarter inches. Each version fits a different size of a universal square hitch mounting assembly 18. In addition to a heavy mounting head at the appropriate gauge listed above, each Trailer Hitch Flags pole assembly 10 contains a solid pole 14 measuring approximately twenty inches in length and one half inch in diameter. This pole 14 extends outwardly at an approximately forty five degree angle from one of the box coupling's four major faces. The box coupling 22 has an angled hole for receiving the pole 14. The box coupling fits into the trailer hitch mounting assembly 18.

The present invention is constructed as a single object either through an injection molding process, milling process or casting process. Fittings for attaching flags are incorporated into this initial one piece build or applied at the conclusion of the manufacturing process.

Using the Trailer Hitch Flags system is as easy as changing out any other custom fitting from a car or truck's box junction hitch assembly. Any fitting currently in place, most likely a ball hitch, is removed. Some fittings, such as aforementioned ball hitches, are held in place by pin and cotter system. Other fittings, such as inexpensive protective caps, are simple pressure fitted covers that slide off with no need for mechanical separation. Once the square fitting is empty, a Trailer Hitch Flags insert of the appropriate dimensions is inserted into the square fitting's central cavity. The Trailer Hitch Flags attachment is affixed firmly in place by mechanically securing it with a pin and cotter. The frictional force of the air against any flag or banner most likely exceeds the force of air which naturally holds the fitting into the receiver tube. Once the fitting is properly secured, the team flag of one's choice, or any other flag selection, is affixed to the pole for simple and routine display.

The Trailer Hitch Flags system allows owners of cars and trucks to experience the same joyful exuberance and team supporting solidarity that flag waving motorcycle riders have enjoyed for years. The present invention provides a driver an opportunity for greater self expression while encouraging greater driver safety and conscious vehicle maintenance. Affordable and durably constructed with quality materials, the Trailer Hitch Flags will withstand many years of flag bearing and safety functionality.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A pole connection device for receiving a pole extension on the rear of any hitch equipped vehicle and functions to securely hold a flag or pennant, comprising:
a box coupling that fits into a trailer hitch mounting assembly wherein the box coupling comprises an angled hole for receiving a pole, wherein the pole is suitable for displaying a flag or pennant.

2. The pole connection device of claim 1, further comprising a pole that fits into the hole in the box coupling.

3. The pole connection device of claim 1, wherein the pole is approximately twenty inches in length and approximately one half inch in diameter.

4. The pole connection device of claim 1 wherein the hole in the box coupling is at approximately a forty-five degree angle.

5. The pole connection device of claim 4, suitable for use with a one and one quarter inches size trailer hitch.

6. The pole connection device of claim 4, suitable for use with a two inches size trailer hitch.

7. The pole connection device of claim 4, suitable for use with a three and one quarter inches size trailer hitch.

8. The pole connection device of claim 4, suitable for use with a five and one quarter inches size trailer hitch.
